(19) United States
(12) Patent Application Publication
(10) Pub. No.: US 2024/0342953 A1
(43) Pub. Date: Oct. 17, 2024

(54) CONTROL OF A 3D PRINTER FOR THE ADDITIVE MANUFACTURING OF BUILDINGS

(71) Applicant: PERI SE, Weissenhorn (DE)

(72) Inventors: Maximilian LUTZ, Nuernberg (DE); Yannick MACIEJEWSKI, Beilstein (DE); Bruno TORRINHA, Krumbach (DE); Fabian MEYER-BROETZ, Günzburg (DE)

(21) Appl. No.: 18/683,355

(22) PCT Filed: Aug. 8, 2022
(86) PCT No.: PCT/EP2022/072216

§ 371 Date: Feb. 13, 2024

(30) Foreign Application Priority Data
Aug. 13, 2021 (EP) 21191280.3

(51) Int. Cl. B28B 17/00; B28B 1/00; B33Y 50/02; B33Y 70/00

(52) U.S. Cl. CPC B28B 17/0081; B28B 1/001; B33Y 50/02; B33Y 70/00

(57) ABSTRACT

A computer-implemented method is employed for actuating a 3D printer for an additive manufacturing method, in particular filament printing, of structures of a building with concrete or other construction materials. The method may include reading in a 3D model via a CAD interface, in which model the structures are represented in an identifiable manner in structural data in a first design format, reading in printer parameters via a printer interface which parameters represent requirements and/or design specifications of the 3D printer and executing a structure conversion algorithm which uses the structural data represented in the first design format to calculate filament structural data in a second design format for a filament structure on the basis of the printer parameters which have been read in. Control instructions are calculated based on the calculated filament structural data, and the calculated control instructions are transmitted to the 3D printer for the purpose of control.

The present invention resides in the field of additive manufacture in the construction sector and relates, in particular, to a software product for actuating a 3D printer for the additive manufacture of constructions, buildings and/or the components thereof.

The term “additive manufacture” (often also referred to colloquially as 3D printing) includes different manufacturing methods which differ fundamentally from conventional production processes and result in completely novel technical possibilities. Components are built up layer by layer and are not produced by removing material as in conventional methods.

If additive manufacturing is to be used in the domain of construction and/or building construction, specific requirements and conditions are to be observed. On the one hand, the material (e.g. concrete) differs from the typical materials which are typically used in 3D printing (e.g. synthetic material, metal, ceramic) and must adhere to specific requirements and also the dimensions of the 3D printer with its components (print head etc.) and the required additional elements have greatly different sizes or dimensions than, for instance, 3D printers for e.g. toolmaking or dental technology. On the other hand, 3D printing is based on 3D model data of the component to be manufactured. In the domain of construction, the planning data for a building are provided by a planner, such as e.g. an architect, with corresponding digital planning software. However, these planning data cannot be used unchanged as input data for a 3D printer because the 3D printer sometimes requires additional information and/or sometimes requires deviating design specifications. The deviating design specifications can make provision e.g. that filament structures are printed, whereas—in contrast thereto—the architectural planning data make provision for solid structures (e.g. solid walls).

The previous 3D printing methods in other fields of technology cannot readily be transferred to the construction sector. On the one hand, concrete, the most commonly used building material in the world, differs fundamentally from the typical 3D printing materials, such as synthetic material, metal, or ceramic, in terms of its solidity and/or surface quality. In addition, there are other requirements regarding the dimensions of the installation space which should be larger than the building to be constructed.

Extensive adaptation steps are thus required for an automated process for efficient digital manufacturing preparation. However, an efficient manufacturing preparation process is crucial for the rapid implementability of 3D concrete printing projects and for the desired scaling of the method. Currently, there is still a great need for optimization, particularly when creating the 3D printing model, because traditional architectural planning differs fundamentally from the structure of a printable building model or data record. Therefore, the planning data which are currently provided by architectural planning generally cannot be used for 3D printing or for creating a printing model for the 3D printer, and manual remodeling or reworking of the planning data for use in a 3D printer is very complex and error-prone.

Against this background, the object of the present invention has been that of making additive manufacturing applicable also to the construction of buildings or building structures/constructions (bridges, dam walls, etc.) and of providing an automated process for the provision of control data for a 3D printer for printing buildings or constructions. Furthermore, the conversion of data from an architectural model into a 3D printing model is to be automated and errors therein to be reduced to a minimum.

This object is achieved by the accompanying independent claims, in particular by a computer-implemented method, by a transformer, by a system and by a computer program product.

In a first aspect, the invention relates to a computer-implemented method for actuating (controlling) a 3D printer for an additive manufacturing method, in particular filament printing, of structures of a construction or building by means of liquid or powdery printable building materials, comprising the steps of:
reading-in a 3D model via a CAD interface, in particular a BIM-enabled 3D model, in which the structures to be printed are identifiably represented in structure data in a first design format (first constructional format);
reading-in printer parameters via a printer interface which represent requirements and/or design specifications of the 3D printer;
executing a structure conversion algorithm which calculates filament structure data in a second design format (second constructional format) for a filament structure from the structure data represented in the first design format, in dependence upon the read-in printer parameters;
calculating control instructions on the basis of the calculated filament structure data, and
communicating the calculated control instructions to the 3D printer for actuating or controlling same.

The 3D printer is one which is suitable for printing large-scale (e.g. large) buildings or constructions (such as bridges, dams, etc.) and therefore can print and operate e.g. in a range of 5 to 300 m². By reason of the large dimensions, the printer has specific requirements in comparison with printers of e.g. tools or implants in the medical sector. This is particularly evident in the significantly more complex material management for the print material to be processed (e.g. 30 tons silo with delivery pump up to 100 bar hose pressure). The print head has a reservoir for the incoming 3D print material, from which the material is delivered to the output location (3D print nozzle). Various attachment parts function as a nozzle, such as e.g. fixed nozzle openings having a different width (e.g. 2-15 cm), nozzle openings with fixed or controllable wings for smoothing and/or orienting the surface (also e.g. 2-15 cm wide) and attachment nozzles having a controllable nozzle width for non-linear filament widths (e.g. 5-60 cm). The printer requires a printing model for printing purposes. In the solution to the aforementioned problem, the printing model is represented in filament structure data. The filament structure data are surface data. In particular, the filament structure data are not volume data.

The structure is a constructional element or a structural component of a building or another structure or construction in any geometry (e.g. as a wall, ceilings and/or furniture structure or structure for a chimney inlet). The structure can be designed as a vertical wall structure and/or as a horizontal ceiling structure. Preferably, the structure can be a vertical structure. In addition to walls, ceilings can also be printed (e.g. as a prefabricated part next to the location of the actual house). These ceilings can be made in any thickness, in that the filaments serve as edge formwork and are then lined with filling material (e.g. fresh concrete) or are 3D-printed in their entirety by the planar printing of layers.

The printable building materials are not limited to a specific class of building materials. In a preferred embodiment of the invention, a flowable and hardenable building material, in particular concrete and/or mortar, is to be used as the building material and in particular in a printable form. This requires specific rheological prerequisites, including viscosity as a measure of flowability and/or flow behavior. Typically, a dynamic flow limit can be in the range between 400 and 2000 Pa (Pascal) and/or a plastic viscosity can be in a range between 20 Pas and 70 Pa·s (pascal-second).

However, the printable building materials can also be cement mortar and/or printable materials, possibly also with the admixing of fibers which serve as reinforcement, such as carbon fibers or synthetic material mixtures. The printable building materials can also be designated as 3D printing material. The printable building materials can include aggregates, such as sand, gravel, expanded clay, foam glass and further solid building materials. The printable building materials can include binding agents, such as cement, but also pozzolana-containing materials or geopolymers and/or additives (depending upon the desired functionality, e.g. as stabilizers, accelerators, plasticizers, viscosity modifiers, plasticity modifiers, shrinkage reducers, dyes, additives for mass hydrophobizing, etc.).

The 3D model can be a CAD model or a model for building construction. The 3D model is preferably a BIM-enabled model (BIM: building information modeling). It can be an architect's model. The architect can plan e.g. a wall as a solid wall or as a formwork wall or two or more parallel formwork walls. It can be e.g. an Autocad model, Revit, ArchiCAD or Allplan model. The 3D model does not typically take into account or represent any printer parameters. The 3D model is characterized by the fact that it does not include any specifications relating to the printer and/or requirements of the filament structure to be printed. In contrast thereto, the aforementioned parameters and details are included in a so-called “printing model” which is designed specifically for the 3D printer. The printing model can be processed directly by the 3D printer.

The printer parameters are technical characteristics of the 3D printer. The printer parameters represent requirements and/or design specifications of the 3D printer. The printer parameters can include e.g. a nozzle width and/or a feed rate of the print head.

In a further preferred embodiment of the invention, the printer parameters can be selected e.g. from the group consisting of: layer height, rounding radius, nozzle offset (in the printing direction) and/or layer time (indicates the duration for a completely printed layer or when the print head returns to the same coordinate point. Therefore, this value (“layer time”) is particularly relevant. The printer parameter “layer time” can be calculated preferably automatically in dependence upon a setting parameter which characterizes the setting time of the concrete. The setting parameter can be input manually via a user interface or it can be read out from a material database. Preferably, a layer algorithm is used to calculate the layer time and is intended to keep the layer time shorter than the setting time of the concrete or the respective printable building material used.

In a further preferred embodiment of the invention, the printer parameters can be selected e.g. from the group consisting of: printing speed, extrusion coefficient, hose length, mixing tool and/or ambient conditions, such as temperature and/or humidity, etc. The extrusion coefficient indicates how fast an extruder screw rotates in the print head. The actuators for moving the extruder screw are actuated depending upon the values output by the structure conversion algorithm (e.g. print or do not print).

The term “filament structure” relates to the structure to be printed, e.g. a wall, such as e.g. the wall of a building or partial wall or a ceiling, etc. The filament structure can be designed e.g. as a filament wall with at least one filament wall element and preferably at least two or more filament wall elements which are preferably spaced apart from one another and even more preferably are arranged spaced apart substantially in parallel with one another. In the design as a filament wall structure or filament wall element, it can comprise two or more wall elements which have dimensions in cross-section which correspond substantially to the dimensions of the associated structures identified from the 3D model in the first design format, e.g. a solid wall planned in the 3D model. The space which extends around between at least two wall elements, which are arranged spaced apart from one another, can be filled e.g. with reinforcements, insulating material, concrete, a filament structure as “infill”, e.g. in the form of a serpentine line, or combinations thereof. In a simple embodiment of the invention, the calculated filament structure can also consist only of a filament element (e.g. wall).

Filament printing characterizes the printing procedure for printing filament structures. The printing method can preferably be an extrusion-based 3D concrete printing method which is based upon extrusion-based distribution of the concrete. Fundamentally different printing methods can be used for extrusion-based concrete printing methods, which differ mainly in terms of the size of the deposited filament and the printing strategy based thereupon:
fine filament deposition according to the Loughborough method,
medium-fine filament deposition of the Contour Crafting Concept of the University of Southern California and
coarse filament deposition of the CONPrint3D concept of the University of Technology of Dresden.

For this purpose, reference is made to the publication: “A process classification framework for defining and describing Digital Fabrication with Concrete”, https://doi.org/10.1016/j.cemconres.2020.106068 https://www.sciencedirect.com/sciecne/article/pii/S0008884619316709. In all extrusion-based printing methods, “a premixed material is deposited through a nozzle at specified pressure rates at specified coordinates” (Mechtcherine, Viktor; Nerella, Venkatesh Naidu (2018): 3-D-Printing with concrete: Current status, development trends, challenges. In: Bautechnik 95 (4), pages 275-287. DOI: 10.1002/bate.201800001). However, in the case of concrete, this definition must be slightly differentiated because, in this case, the extrusion result is not exclusively limited by the shape of the nozzle opening. Instead, the soft fresh concrete mixture is pressed out of the nozzle and then flows away into a different filament geometry by reason of its own weight (Mechtcherine, Viktor; Nerella, Venkatesh Naidu (2018): 3-D-Printing with concrete: Current status, development trends, challenges. In: Bautechnik 95 (4), pages 275-287. DOI: 10.1002/bate.201800001.). In order to obtain an optimum printing result, the printing sequence must be performed as continuously as possible. Rounded corners and/or edges are suitable for this purpose because the print head can move over them without interruption. The provision of the control data for actuating the 3D printer for these rounded corners and/or edges is implemented by means of a radius algorithm in accordance with this proposal.

The radius algorithm determines curves to be printed in the model, i.e. vertical edges are rounded. These curves are imaged by the print head such that the print nozzle at the lower end of the print head is actuated accordingly and rotates with the curve, as it were, about the z-axis. The print nozzle can have e.g. a rectangular cross-section. If the print nozzle did not rotate and the print head moved around a curve, the width of the filament structures would no longer be correct. However, if the print nozzle has e.g. a round cross-section, the nozzle may not have to rotate, but only the print head must be actuated so that the curve is traced and printed, as calculated from the model. In each case, the print head must be controlled such that a curve is printed.

Vertical extrusion is effected by means of an increasing number of consecutively deposited layers. In this case, the rate of the material deposition plays an important role with regard to layer binding and uniformity. Excessively quick deposition leads to an irregular and untidy extrusion result because the increased intrinsic weight of the added upper layers allows the lower layers to leak laterally if they do not yet have sufficient strength. In contrast thereto, excessively slow deposition can prevent proper adhesion between the individual layers because the lower layer in each case has already set too much and does not bond with the freshly deposited layer. This can result in insufficient stability and durability of the components (Meyer-Brötz, Fabian (2019): 3D Construction Printing, 2019).

Furthermore, “the dimensional accuracy and dimensional stability [ . . . ] are crucially dependent upon the rheological properties of the printed concrete” (Mechtcherine, Viktor; Nerella, Venkatesh Naidu (2018): 3-D-Printing with concrete: Current status, development trends, challenges. In: Bautechnik 95 (4), pages 275-287. DOI: 10.1002/bate.201800001). Therefore, this parameter must be taken into account when translating the planning data from the CAD model (of the architect) into the G-code which can be processed by the construction printer in order to ensure optimum control of the print head.

In a preferred embodiment of the invention, the filament structure data can be represented as surface (plane) data. The surface relates to the surface which is formed by the center longitudinal axis of the structure to be printed. In the case of a vertical wall structure, this is the vertical surface which is spanned by the center plane of the wall structure and thus divides the wall structure in half in terms of thickness.

The first and/or second design (constructional) format can match. However, the first and/or second design format will preferably not (exactly) match. The design format can be e.g. a design scheme (e.g. wall design scheme, such as a solid wall/formwork wall).

The first design format can be configured e.g. to represent a solid wall, preferably including the details of length, width, and height.

The second design format c (aka constructional format) an preferably be configured to represent a filament structure. In order to specify the filament structure exactly, the second design format can sometimes include the following filament structure parameters: number of filament structures, thickness of the filament structures, intermediate space or (depending on the number) intermediate spaces, filler for filling the intermediate spaces, etc.

In general, it is the case that further parameters and design details are required in order to calculate the filament structure, some of which are dependent upon the printer parameters in order to be able to print the respective structure. Typically, the structure data in the first design format does not exactly match the filament structure data in the second design format. This also applies even when the architect has already planned the structure, e.g. the wall, as a filament wall. In this case, the calculated filament structure data differ from the structure data (from the CAD model) by virtue of, inter alia, the adaptation functions for taking the printer parameters into account and by virtue of the transformations in relation to the radii (radius algorithm). In most cases, the filament structure data differ from the structure data cumulatively or alternatively in that the architect plans with volume data, whereas the printing model requires surface data. In a first example, the architect plans the entire structure, in particular the wall, as a solid wall, i.e. as a volume body in 3D. In a second example, the architect plans the filaments to be printed (i.e. a cavity wall), but the filaments are not stored as surface data, but as volume bodies in the 3D model. Therefore, the structure data must be transformed into filament structure data which can be used by the printer and are present in surface data.

Surface data for a filament structure can fundamentally be calculated from one or more structures. Particularly in the case of small structures, such as reveals and/or lintels, it has proven to be advantageous that the structures are partially connected to one another before the calculation to form a structure portion, e.g. individual wall portions of a structure can be connected to form a coherent wall structure. A large structure can also be broken down into individual structure segments. Subdivision into printing segments or portions is dependent upon the layer time. In turn, the layer time is dependent upon the material used. Different materials have different setting times. The layer time is preferably determined such that it does not exceed the setting time of the material and the layer time is preferably less than the setting time. Furthermore, the layer time is dependent upon the printed component geometry/geometries, the movement of the print head between the component geometries and the printing speed. The layer time L can thus be understood as function f:

$$L : f ( m , p , g , v ) ,$$

where m is the material type, p is the pressure, g is the geometry with a print head movement, v is the speed of the print head. A further relevant influencing parameter which, according to a preferred embodiment of the invention, can be taken into account when calculating the layer time is the so-called “travel move”. This refers to the movement of the print head between in each case two portions or geometries to be printed or the associated time phases in which no material is extruded. If e.g. two separate structure elements (e.g. two columns) are to be printed and are self-contained as a structure element, the calculated control instructions instruct the print head in such a way that the print head has to oscillate back and forth as it were from the first structure element (first column) to the second structure element (second column). The movement of the print head is defined by the control instructions and in particular by a movement portion. The control instructions also include a material portion which defines that material is extruded only at the points where the respective structure/column is to be produced. Depending upon the distance between the two structures and therefore depending on the distance the print head has to bridge, the “travel move” is longer or shorter and thus has a greater or lesser influence on the layer time at the same speed.

The printing speed indicates how quickly the print head moves in the space, e.g. ca. 1 cm/s to 100 cm/s.

The wall structure which is calculated using the structure conversion algorithm must be traversed accordingly by the print nozzle of the print head (movement portion data) and the structure must be printed/produced from the material (material portion data).

For this purpose, provision is made that apertures are calculated. By reason of the apertures included in the model, the print nozzle is actuated in such a manner that, in a targeted manner at specific points, it prints and does not print (precisely where there are apertures). In the case of apertures, the print nozzle is thus specifically actuated in order to interrupt the print material.

The structure conversion algorithm is used to calculate the filament width. The digitally planned filament width and the position of the filament center axes relevant for the printing model change depending upon the selected width of the physical printer nozzle opening. Therefore, in a preferred embodiment of the invention provision is made to specify the printer nozzle on a user interface (UI). A printer nozzle width data record is created from this. Cumulatively (for the purpose of verifying the manual input of the nozzle width) or alternatively, the printer nozzle width data record can also be read in from a database or from a memory (e.g. of the printer). From this printer nozzle width data record the structure conversion algorithm automatically calculates the filament width and determines the position of the filament center axes. A wider printer nozzle leads to wider filament structures and consequently to smaller spaced intervals between the filament structures in the case of multi-filament structures.

Cumulatively or alternatively, the structure conversion algorithm serves to calculate aperture details. The aperture details are, inter alia, dependent upon the nozzle width and are also then printed via the print nozzle. Calculated reveals which extend orthogonally to the filament axis and associated support structures (so that the orthogonal reveals do not e.g. fall down) must be printed by means of the print nozzle. Voids are created for the apertures and for the lintels, which are to be inserted, above the apertures. In this case, the print nozzle is then stopped and so no material is printed or deposited (material portion of the control instructions).

Cumulatively or alternatively, the structure conversion algorithm calculates the printer configuration. The optimum printer configuration (length×width×height of the installation space) can be calculated from the final model, and the printing duration/layer time and/or the amount of printing material can be ascertained. To this end, printer configuration data are created.

Cumulatively or alternatively, the structure conversion algorithm is used in order to avoid nozzle offset. In a preferred embodiment of the invention, the structure conversion algorithm includes a nozzle offset avoidance function for this purpose. In the case of calculated positive surface data, the print nozzle is actuated in order to print the structures. In the case of apertures, the print nozzle is actuated in such a way as not to print at these locations. If the print nozzle is actuated so that it is stopped, in many cases it is not possible to prevent material from still running on and thus material being applied when no material should be applied (nozzle offset), e.g. if there is still material in the nozzle and it continues to drip or there are other delays between the stop signal and the actual stop (no application of material). Consequently, an aperture could possibly no longer be the correct size or could be inaccurate because there is more material around the aperture than there should be. This can be particularly critical in the case of small apertures, e.g. for TGS installations (electrical, sockets) etc. because it may no longer be possible to insert a socket.

The nozzle offset avoidance function changes the path—to be travelled—of the print nozzle (change in the movement portion) at the positions detected as critical (all positions adjacent to an aperture), in that, at a first end of the structure to be printed which is followed by an aperture—as seen in the printing direction, the print nozzle deviates (or is actuated accordingly) from its calculated linear movement and performs an e.g. orthogonally inwardly pointing movement in the direction of the cavity of the wall structure. As a result, any surplus residue of the print material escaping from the print nozzle is not deposited in the longitudinal direction but instead e.g. orthogonally thereto into the cavity of the wall. Short arms or lumps of residual material escaping from the print nozzle after the instructed pressure stop are not deposited linearly, but instead at an angle (e.g. orthogonally) in a cavity (of the wall structure). The nozzle offset avoidance function can also be used inversely for a second end of the aperture in order to ensure that material also issues out of the nozzle after printing has started and does not have to be provided from the supply lines until it can be deposited by the print nozzle. In this case also, provision can be made that the print nozzle performs an additional movement into and out of the cavity of the structure. The time phase for performing the additional movement is dimensioned in such a way that sufficient printing material is reliably available in the print nozzle when it has reached the second end of the aperture.

In a preferred embodiment of the invention, the control instructions are represented in a G-code or can be transformed into a G-code which can be read in and directly processed by a control board or a control unit of the 3D printer. This has the technical advantage that no further conversion steps have to be performed and the control instructions can be read in and processed directly by the 3D printer. The control instructions can be processed directly by the 3D printer. The control instructions can include at least two portions:
1. a first portion which functions as a movement portion and defines the movement (the path to be travelled by a print nozzle of the print head of the 3D printer). The movement portion can cumulatively or alternatively comprise further movement-related parameters, such as e.g. a speed, acceleration, jerk, etc. Alternatively, or cumulatively, the movement section can preferably also comprise a rotation portion which defines how a print nozzle of the print head must rotate in relation to a point or a portion of the path. The rotation portion can comprise in particular an angle of rotation and a direction of rotation.
2. a second portion which functions as a material portion and defines how quickly and how much material and whether any material at all is to be deposited on the print path and at which position.

The control instructions are used to control (instruct) the 3D printer to additively produce the structures of the construction by means of the 3D printer in accordance with the specifications from the 3D model (which can originate e.g. from an architect) which is read in via the CAD interface.

In a further preferred embodiment of the invention, the method and in particular the calculating of control instructions, comprises so-called “slicing” of the structure to be printed. In this case, “slicing” describes segmenting of the structure to be printed. Slicing is effected by executing a slicing algorithm which calculates slicing data for the calculated filament structure data for selected structures in dependence upon the read-in printer parameters and/or in dependence upon specifications from the read-in 3D model, said slicing data defining in particular a layer height.

Slicing thus relates to a partitioning of the structure to be printed. The slicing is typically dependent upon a type of the 3D printer and/or upon the building material used (e.g. in terms of viscosity and setting time). The slicing can be performed e.g. in a horizontal and/or vertical plane and/or according to specific spatial specifications and serves to subdivide a printing portion. Provision can thus preferably be made to define a slicing height or a layer height according to hardening specifications of the material. This has the technical effect that the method can be adapted very specifically to the respective application and the specifications on site.

During slicing, the filament structure data (or the surface-based printing model) is converted into a specific instruction list for the 3D printer. The model is imported in a STEP or IGS format into slicing software where the vertical surfaces are divided into horizontal paths which specify the linear movement of the print head. Depending on the type of 3D printer, further settings, such as the nozzle width and printing speed which are used, can then be made. This information is used to generate a so-called G-code file which can be read and interpreted by a control board of the 3D printer via the web interface. The slicing software or the slicing algorithm can be implemented directly on the 3D printer.

In one advantageous development of the invention, provision is made that filament structure parameters, in particular a width in each case of a filament structure to be calculated and/or a layer height for slicing of the filament structure, can be configured on a user interface via corresponding configuration fields. This improves the flexibility and also the applicability of the method. Cumulatively or alternatively, the structure conversion algorithm can be executed on the basis of the filament structure parameters.

In a further preferred embodiment of the invention, the printer parameters can include a nozzle width and/or a printing speed of the print head, a layer height, a rounding radius, nozzle offset and/or layer time, printing speed (i.e. the feed rate or speed at which the print head is moved), extrusion coefficient, hose length, mixing tool (e.g. continuous mixer, pan mixer, twin shaft mixer) and/or environmental conditions, such as temperature and/or humidity. The nozzle offset is an offset between the nozzle and print head. The center point of the print head does not have to be the center point of the print nozzle at the bottom of the print head. This is important in particular when printing close to existing structures. If, in addition, the print nozzle can be rotated in a horizontal direction (in relation to the print head), the entire gantry must move accordingly during printing around a curve if the center point of the nozzle is not the center point of the print head.

The structure conversion algorithm is generally used for model conversion from the CAD architectural model to the printable model or “printing model”. The conversion of the structure data (in particular volume data) from the CAD model into filament structure data (in particular surface model) is effected in dependence upon the printer parameters. The printer parameters are incorporated into the algorithm preferably at different points. The nozzle width is e.g. often halved in order to produce the filament center axis in parallel with a wall boundary.

In the case of a longer hose (can vary from a few meters to more than a hundred meters), the material to be printed hardens on the way to the print nozzle. Accordingly, the layer time must be reduced by either increasing the printing speed or reducing the length to be printed in the respective print portion in order to achieve the desired layer pattern.

In a preferred embodiment of the invention, the filament structure data can be generated by means of a BREP (Boundary Representation) method and/or by means of a CSG (Constructive Solid Geometry, Boolean geometric model) method. These methods are used for the standardized digital representation of three-dimensional (geometric) objects.

In a further preferred embodiment of the invention, the method can include a radius algorithm which calculates a radius for all or selected adjacent structure elements which have a connection region, in particular a connection edge, via which radius the two adjacent structure elements are connected during the printing procedure. This has the advantage that rounded corners and/or edges which can be implemented by the 3D printer are automatically modeled. In purely geometric terms, the rounding radius should be greater than or equal to half the nozzle width for a neater printing procedure in order to avoid overlapping at the edges.

In a preferred embodiment of the invention, a gantry printer is used as a 3D printer. However, the method is basically independent of a type of printer. The 3D printer can basically be designed as a gantry printer or as a gantry crane. Furthermore, other different types of printers can be used, such as a cable robot, a single-armed or multi-armed robot, a robot which is fastened to a mast structure or other variants.

The filament structure elements can be arranged in parallel or substantially in parallel with one another. It is also possible that at least one filament structure element, e.g. a center filament structure element arranged between the outer filament and the inner filament, is arranged at an angle, in particular in an angular range between 0° and 90° in relation to the outer filament and/or the inner filament, at least in a partial region in relation to a printing axis (which is defined by the printing direction or by the axial movement of the print head). This allows walls to be printed which consist of two outer parallel filament surfaces and at least one further filament is provided in the interior of the structure, which filament has a sinusoidal profile, a zigzag profile or a rectangular profile in plan view or does not necessarily have to be located centrally between the two outer walls, but can also be arranged off-center in order to form e.g. two hollow chambers of different widths for filling with insulating material.

For example, a three-part filament structure wall can be formed, with an outer filament and an inner filament arranged in parallel therewith and an intermediate filament which is arranged therebetween and can extend either in parallel or in a predefinable pattern, e.g. zigzag or according to a sinusoidal oscillation or according to a step function. The spaced intervals between the intermediate filament wall and the respectively adjacent filament walls can be configured. This can be effected via a user interface in a configuration phase.

In a preferred embodiment of the invention, the filament structure can comprise at least one or two filament structure element(s), with at least one outer filament for forming an outer boundary of the building (outer wall) and at least one inner filament (for the inner separation of rooms or for delimiting an outer wall with respect to the inner space of the building). An outer surface of the outer filament and an outer surface of the inner filament can have, in the printed state, a spaced interval from one another which corresponds to a width of the structure from the read-in 3D model. This applies in particular in the case of two-filament or multi-filament (multi-shell) wall structures. Alternatively, or cumulatively, the filament structure can also be e.g. a ceiling or a ceiling element. The inner filament is then arranged on a side facing the inner space and the outer filament is arranged on a side facing away from the inner space. The ceiling or a ceiling portion can be printed as a closed rectangle e.g. in a plan view. In this case, there is no inner filament. Then, the spaced interval between the outer surface of a first outer filament and the outer surface of a second outer filament would correspond to the width of the structure from the read-in 3D model.

In a preferred embodiment of the invention, the method and in particular the structure conversion algorithm and/or a void algorithm, a radius algorithm, a slicing algorithm and/or a detail aperture algorithm is implemented with a visual programming language, in particular Rhino by Grasshopper, which can run on a 64-bit Windows application. In principle, the computer-implemented method can also be hard-coded and so the automated conversion of 3D model data (planning data, e.g. of the architect) into filament structure data, which can be converted into control instructions by a 3D printer, can also be used independently of the visual programming interface in a user-friendly (CAD) environment.

In a preferred embodiment of the invention, the method generates not only the control instructions but also visualization data, in particular for 3D visualization of a structure, which is to be printed, from the calculated filament structure data. This can advantageously serve as a verification step for output on a user interface UI. This allows the safety and reliability of the method to be improved by providing a correction loop or correction option. Preferably, the generated visualization data can be exportable in a standardized format, in particular DWG and/or IFC, and can be transferable to external entities.

In a further embodiment of the invention, the method can comprise at least one of the following steps:
executing a void algorithm which defines apertures in the structures and, based thereon, calculates aperture volume data in dependence upon the read-in printer parameters; wherein the calculated aperture volume data serve as a section body for the filament structure data for calculating the same and/or
coordinate transformation of the calculated data, in particular the calculated filament structure data, into a coordinate system of the 3D printer.

The void algorithm (Abzugskörper-Algorithmus) can be used as an additional module. For example, it is feasible to print building or constructions (e.g. hall walls) or structures or structure parts (e.g. ceilings) of buildings which do not have any apertures. This module is therefore optional and can be added if required, but is not absolutely necessary. However, the vast majority of print jobs will have apertures in different forms (as a door, window and/or installation aperture etc.).

In a preferred embodiment of the invention, an additional subtraction method step can be performed by subtracting the calculated aperture volume data from the calculated filament structure data in order to provide positive surface data for the structure to be printed. This positive surface data represent all structure regions, in particular wall regions which have no apertures (i.e. where material is printed). The aperture volume data are used as 3D section bodies when calculating the filament structure data. The aperture volume data can preferably also be output on a UI. This has the advantage of additional verification. A plausibility check can also be performed, e.g. in order to ensure that two different aperture volume data are not provided at a corresponding position. For example, an aperture for a door and an aperture for a window are not typically provided in identical positions. In this case, a verification message can be issued to the user who can then confirm or reject this.

In a preferred variant of the invention, the void algorithm performs a difference operation. The difference operation can be performed by a difference algorithm in order to subtract aperture volume data from the calculated surface data (filament structure data in the second design format) in order to determine the vertical structure to be printed. The result of the difference operation is therefore the filament structure data in the design format in which it is to be printed. The filament structure data can thus also include apertures. This has the technical effect that positive surface data are calculated which represent the sum of all regions of the structure to be printed, e.g. all wall regions of a wall structure in which a door and/or a window and/or other apertures, e.g. for laying electrical or sanitary lines, can be formed. The calculated positive surface data can preferably be visualized on a user interface for verification by the user. Therefore, the security of the method can be increased.

As soon as the structure to be printed including apertures is calculated, the structure conversion algorithm calculates the types of apertures (e.g. technical building fittings such as sockets, LAN boxes, etc., windows, doors) and generates further/new surface data for details (technical jargon in the construction industry) for the apertures, e.g. reveal (e.g. for windows), electrical planning details (such as e.g. a thickening of the wall in order to be able to insert a socket etc.) depending upon the type of aperture.

In a further preferred embodiment of the invention, the calculated filament structure data can be exported and modified in an intermediate step, preferably in a list format, and can be fed back to the method e.g. in modified form and further processed. This has the advantage that the automatically calculated filament structure data can be relayed to an external entity (e.g. to the planning architect and/or the builder and/or the operator of the 3D printer). Modifications can then be made—as required-on this external computer-based entity. A modified filament structure data record is then generated and can be fed back to the (computer-based) transformer in order to perform the above-described method. The steps of calculating control instructions and communicating the calculated control instructions are then effected on the basis of the modified filament structure data as acquired by the external entity.

The achievement of the object has been described above by reference to the computer-implemented method. Features, advantages, or alternative embodiments mentioned herein are likewise also to be transferred to the other claimed subjects and vice versa. In other words, the claims forming the object (which are directed e.g. to a transformer, system, or a computer program product) can also be developed with the features which are described or claimed in conjunction with the method. In so doing, the corresponding functional features of the method are embodied by corresponding modules relating to the subject matter, in particular by hardware modules or microprocessor modules, of the system or of the product, and vice versa. Taking Church's thesis into account, a software implementation (method) is equivalent to a hardware implementation (device, transformer), at least from the point of view of calculability.

In a further aspect, the present invention relates to a transformer for performing a method, as described above, for actuating a 3D printer for an additive manufacturing method, in particular for filament printing, of structures of a building or a construction or parts thereof by means of liquid or powdery printable building materials. To this end, the transformer comprises:
a CAD interface for reading-in a 3D model, in particular a BIM-enabled 3D model, in which the structures are identifiably represented in structure data in a first design format;
a printer interface for reading-in printer parameters which represent requirements and/or design (constructional) specifications of the 3D printer;
a processor for executing a structure conversion algorithm which calculates filament structure data in a second design format for a filament structure from the structure data represented in the first design format, in dependence upon the read-in printer parameters; wherein, furthermore, the processor is intended for calculating control instructions based upon the calculated filament structure data;
an output interface which is designed to provide at least the control instructions calculated by the processor in order to actuate the 3D printer and to communicate them to the 3D printer.

Preferably, the output interface comprises a user interface, on which the calculated control instructions can be output. This step is used for verification of the control instructions by the user. However, since the control instructions can be comprehended only by trained personnel and are rarely directly understandable, the following implementation is provided.

In a preferred embodiment of the invention, visualization data for the structure to be printed can be provided and output on the user interface. The visualization data are generated from the calculated filament structure data. This offers the substantial advantage that the structure to be printed can be visualized in the version to be printed. The structure to be printed can therefore be easily and efficiently verified or falsified by the user.

Preferably, at least one result data record is generated:
1. Filament structure data from which model data for actuating the 3D printer (also referred to here as control instructions) are calculated.

Cumulatively, a further result data record can optionally be generated, namely in the form of:
2. Visualization data which are calculated from the filament structure data and/or from the control instructions and represent model data for visualizing the structure to be printed (referred to as visualization model).

The visualization model, in particular a volume-based visualization model, shows the building or component to be physically printed in its typical multi-shell extrusion structure and constitutes the rounded wall corners and aperture variants. In a further advantageous embodiment of the invention, the visualization model can be enriched with annotation data, comprising e.g. component and material information. The visualization model can be transferred as a BIM model to external entities which are assigned e.g. to the builder and/or architect.

In parallel or in a downstream or upstream method step, a printing model is created, in particular a surface-based printing model, which specifies the center axes of the filaments to be printed by means of vertical surfaces. The printing model can be provided to a slicing algorithm. The slicing algorithm can be implemented and/or executed on an external entity. The printing model contains control instructions and serves as the basis for generating the tool path of the print head.

In a further aspect, the invention relates to a system comprising a transformer, as described above, wherein the system comprises the 3D printer.

In a further aspect, the invention relates to a computer program product comprising a computer program having instructions which, when the computer program is executed by a computer, cause the computer to perform the method as described above.

In the following detailed description of the figures, exemplified embodiments, which are to be understood to be non-limiting, together with the features and further advantages thereof will be discussed with the aid of the drawing.

### BRIEF DESCRIPTION OF THE FIGURES

FIG. 1 shows by way of example a 3D printer having a print head for filament-printing of a building;

FIG. 2 shows a schematic overview of a transformer for transforming an architectural model into control instructions for a 3D printer;

FIG. 3 is a flow diagram of a method according to a preferred embodiment of the invention;

FIG. 4 shows a further perspective view of the print head of the 3D printer;

FIG. 5 shows possible functions of the structure conversion algorithm;

FIG. 6 shows a list in table form relating to the transformation of the structure data into filament structure data, and

FIGS. 7a, b show a schematic view of an aperture without (7a) and with (7b) a nozzle offset avoidance function.

### DETAILED DESCRIPTION OF THE INVENTION

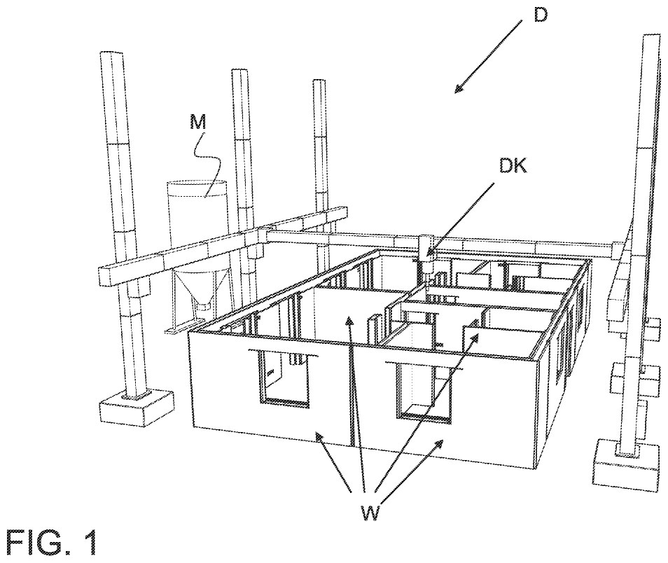

The invention will be explained in greater detail hereinafter in conjunction with the figures. FIG. 1 shows a schematic perspective view of a house as an example of a building which is to be printed with a 3D printer. The house comprises a plurality of vertical structures or walls W to be printed. The 3D printer is designed as a gantry printer and has a scaffold-like or gantry-like structure, on which a print head DK is movably mounted in order to implement control instructions s and move along a specified path. The 3D printer D is preferably operated with liquid concrete and/or mortar-like building materials, in particular with in-situ concrete, which is mixed on site in a mixer M. Supply lines are provided in order to supply the print head DK with concrete. As shown schematically in FIG. 1, the gantry structure of the printer D has a size which is adapted to the size of the building to be printed, but exceeds it so that the print head DK can reach all regions of the building to be printed.

For 3D concrete printing of building or construction structures, the printer D must initially be set up at the intended position. A dry test of the printing procedure without material is preferably performed for calibration purposes. For this purpose, the previously generated G-code is transferred or uploaded via a web interface to the printer D which is connected to the computer via a network. After two to three correctly produced layers, it is to be assumed that the construction printer is correctly calibrated. The concrete mixture can now be directed from a mixing pump M to the print head DK. Before the eventual start of the printing procedure is triggered, a small amount of material can firstly be deposited via manually triggered extrusion in order to verify the flow behavior. While the printer D deposits the concrete mix filament by filament, connection anchors are inserted between the shells and the lintels for windows and doors.

Previous prior art methods are based upon the fact that the 3D model (architectural model) has to be subjected to manual remodeling in a time-consuming and error-prone process before it can be transferred to the 3D concrete printer for implementation. The previous manual remodeling can potentially take several days. The invention proposes automating this process. In addition, a surface-based printing model and optionally, but preferably, a BIM visualization model is generated on the same basis and are thus identical to each other in terms of their structure. By incorporating variable parameters, such as e.g. the filament width and/or the edge and/or corner radius, subsequent change requests can be post-generated within a few seconds and thus provide more transparency in the output of the printing model.

In order to guarantee the safety and reliability of the algorithmic conversion of the model data (architectural model into 3D printing model), there are various requirements for the structure conversion algorithm, including the input and thus the modeling of the architectural model with regard to geometry and classification. In a preferred embodiment of the invention, provision can be made that at least the following input data are acquired:
wall structure data representing the wall structure (inner wall, outer wall), wall type (with or without insulation) and/or core data (with or without concrete core);
wall opening data representing in particular wall openings (in particular for windows and doors) in order to ensure the sealing tightness;
overhang data representing an overhang of the wall; these differ from material to material, e.g. the overhang can be 10° at a pressure head of 1 m; however, this formula can be configured on the basis of new empirical knowledge;
anchor data representing the number of wall anchors; and/or print nozzle data representing which print nozzle is to be intended for which wall structure; alternatively, or cumulatively, the print nozzle data can also indicate whether lateral guide surfaces (flaps) are provided on the print nozzle in order to smooth the printed layer.

The generated filament structure data or the generated 3D printing model inevitably influences the slicing or the generation of the G-code and thus the physically printed building. On the one hand, a geometrically correct surface model is required which can be read and further processed by the slicing software. On the other hand, the rapid adaptability of the algorithm allows various building details to be optimized and can thus be used for the experimental printing of different variants.

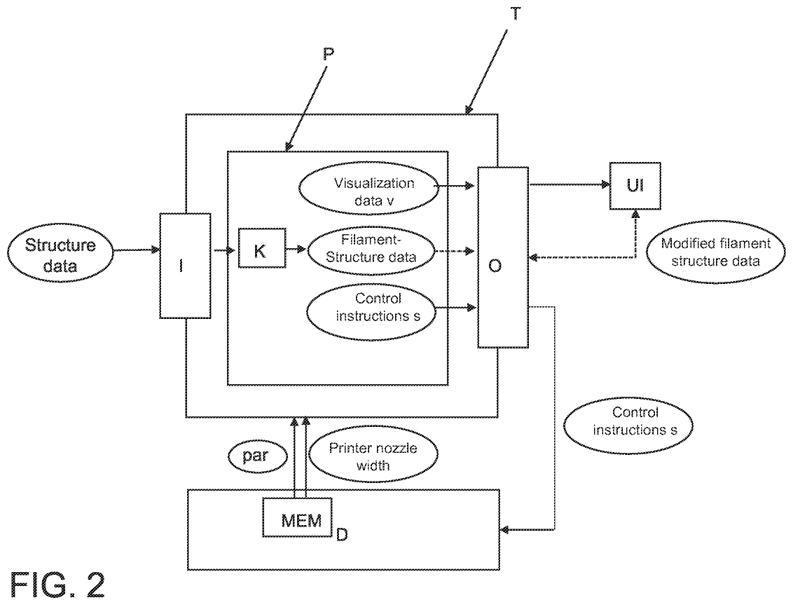

As shown in FIG. 2, the structure data from the architect model must be read in by the transformer T. This is effected by means of the CAD interface I which serves as an input interface. The transformer T is used to execute the structure conversion algorithm implemented therein. The structure conversion algorithm calculates and takes into account parameters par in order to transform the read-in structure data into filament structure data. The parameters par can include printer-specific parameters, such as e.g. nozzle width, print head speed, layer height, rounding radius, nozzle offset and/or layer time and process-related parameters (e.g. material-specific parameters, such as the setting time of the concrete). Preferably, at least one printer nozzle width is communicated to the transformer. Alternatively, or cumulatively, the printer nozzle width can also be read in via the UI. The filament structure data, control instructions s and/or visualization data v generated by the transformer T and in particular by the structure conversion algorithm can be output via an output interface (output) O. The control instructions s are relayed to the 3D printer D for actuation purposes. The parameters par can be read in directly from a memory MEM of the printer.

After reading-in the structure data, the data must be classified in a classifier K. There are essentially two different types of modeling in the classification of building elements: layer-oriented modeling and component-oriented modeling. While, for organization purposes, AutoCAD normally still uses a classic layer system in which the drawn objects are placed on previously created layers according to function and purpose (Autodesk 2019), Revit and ArchiCAD work in a component-oriented manner. In this case, the objects are generated from a stored component database and comprise the associated category, class, and type directly. With regard to generation, the algorithm must therefore be able to filter the building elements both according to a stored layer and according to a specific component class. The classification must be carried out in such a way that, in a first step, all non-printed building elements, such as all conventionally produced structures, are filtered so that only the structures to be printed (e.g. walls) are still present as a basis for the further progression of the transformation. The data records can be classified or indexed according to different criteria, e.g. component type-hierarchically structured (e.g. wall structure, in particular external or internal wall and in particular wall type, in order to automatically distinguish whether it is an insulated, non-insulated or solid printed wall). After classification by the classifier K, the data can be filtered according to the respective criteria.

As with the classification, there are also two approaches in three-dimensional modeling: for instance, volume bodies can be generated by means of a Boundary Representation (BREP) method or a Constructive Solid Geometry (CSG) method. Since the walls of an architectural model created in Revit, ArchiCAD or AutoCAD can each be modeled in both ways, in particular if they are inclined or round walls, the method described in this case can process a BREP and a CSG geometry.

Depending upon the structural-physical function, a wall can consist of one material or can be composed of the wall layers which are defined in a component type or connected to one another in a purely graphical manner. This composition of the different layer widths and the height of a wall portion are to be interpreted by the structure conversion algorithm. In addition, the new design freedom of a 3D-printed building means in particular that there is now a large number of possible forms of wall and wall connections as well as the option of directly also printing furniture and fixtures, such as stoves.

The transformer T comprises a processor P which is designed to execute the structure conversion algorithm. The calculated filament structure data can be output on the output interface O for the purpose of verification. The user can make inputs on an external device with a user interface UI in order to modify the calculated filament structure data and communicate modified filament structure data back to the processor P via the (two-sided) interface, which are then used to calculate the control instructions s. In a preferred embodiment of the invention, the output interface O also outputs visualization data v representing a visualization of all structures W to be printed or of the building to be printed. Corrections can also be made in this case via a modification and the generation of modified filament structure data which are communicated to the processor P.

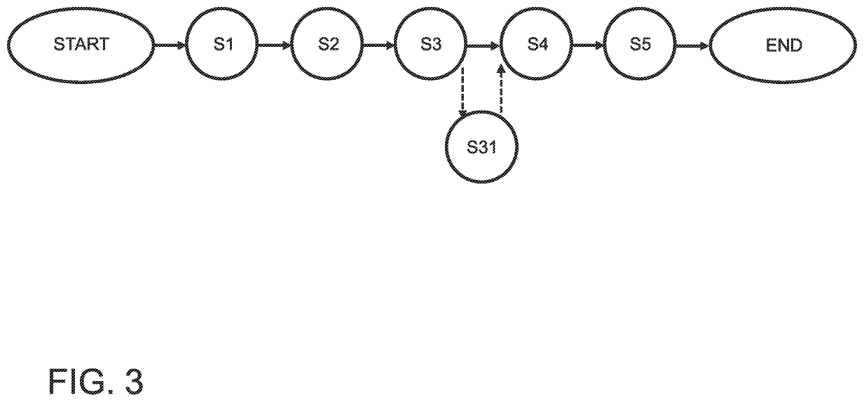

FIG. 3 is a flow diagram of a method according to a preferred embodiment of the invention. After the start of the method, the data of the 3D architectural model is read in via the input interface I in step S1. In step S2, the printer parameters are read in. In step S3, the structure conversion algorithm is executed in order to generate the filament structure data from the read-in data. Optionally, verification can be performed in step S31 by outputting visualization data v on the output interface O. As the step is optional, it is shown as a dotted line in FIG. 3. The visualization data v is interactive and so said data can also be changed by means of corresponding user inputs. The user can input modified visualization data which are then converted into control instructions s in step S4. In step S5, the calculated control instructions s are communicated to the 3D printer D in order to actuate same. Then, the method can end or can be performed repeatedly.

The method and in particular the structure conversion algorithm can include referencing of the wall objects (as an example of a structure to be printed). The referencing can be performed by means of a referencing algorithm. The read-in 3D model is provided as input data to the referencing algorithm which extracts therefrom the wall structures relevant for the concrete printing. In this referencing algorithm, all non-printable components are filtered out of the model, thus guaranteeing that the construction printer receives only the structures, components, or wall objects to be printed.

Cumulatively or alternatively, the structure conversion algorithm can include generating the reveals, lintels and/or support structures. This can be implemented by means of a support algorithm. The voids of the final aperture details are used as input data, from which the support algorithm calculates reveals, support structures and/or voids for the lintels. Based upon the aperture details, the reveals, extending orthogonally to the filament axis, and associated support structures are generated. Voids are created for the lintels, which are to be inserted, above the apertures. The term “support structures” refers in this case to support structures which serve to support the structure to be printed. The material used for this purpose can—but does not have todiffer from the printing material and serves to support delicate or overhanging structures which would “fall victim” to gravity without these support structures as a result of the manufacturing process. Basically, in the case of additive manufacturing, the next layer is applied onto an existing layer. However, this is not always possible for more complex geometries. Support structures are provided for these situations.

Cumulatively or alternatively, the structure conversion algorithm can generate multi-shell wall structure and filament axes. A filament algorithm is used for this purpose. The input generated is solid walls as volume bodies (traditionally planned or already as filaments with volumes) and the output generated is a multi-shell wall structure and filament axes as a vertical surface model. The filament algorithm is used to generate a multi-shell filament wall structure for 3D concrete printing. The digitally planned filament width changes automatically and the position of the filament center axes relevant for the printing model changes depending upon the selected width of the physical nozzle opening.

Cumulatively or alternatively, the structure conversion algorithm can include integration of the TGA apertures and expansion joints. This is implemented by means of an aperture algorithm. The aperture algorithm is provided with TGA planning data as input as a BIM model or position/dimensions in coordinate form, from which voids for the TGA apertures and expansion joints are automatically calculated. The apertures for TGA installations (electrical/heating/ventilation/sanitary) are cut into the model through voids. For a socket (10 cm in height), e.g. 5 layers are omitted for each 2 cm of height. In order to avoid the nozzle offset caused by the interruption in the printing procedure or printing material, the ends of the apertures are placed orthogonally into the cavity of the wall.

Cumulatively or alternatively, the structure conversion algorithm can include an analysis and/or adaption of the window and/or door apertures. This can be implemented by means of an adaption algorithm. The adaption algorithm requires as input the window apertures as voids in order to calculate therefrom voids which are adapted to printable details. By reason of the aperture details specifically adapted for 3D concrete printing (inter alia depending upon the nozzle width), at this point the position thereof can be adapted and/or the clear dimensions thereof can be reduced or increased.

Cumulatively or alternatively, the structure conversion algorithm can include rounding-off of the vertical edges with a preconfigurable defined radius. This can be implemented by means of a radius algorithm. The radius algorithm processes the complete printing model as input in order to calculate therefrom the complete printing model with rounded vertical edges. All vertical edges of the model are rounded off with a defined radius in order to enable maximum linear travel length and thus smooth curves and fast printing speeds. The optimum printer configuration (L×B×H of the installation space), printing duration/layer time and the amount of printing material can be ascertained from the final model.

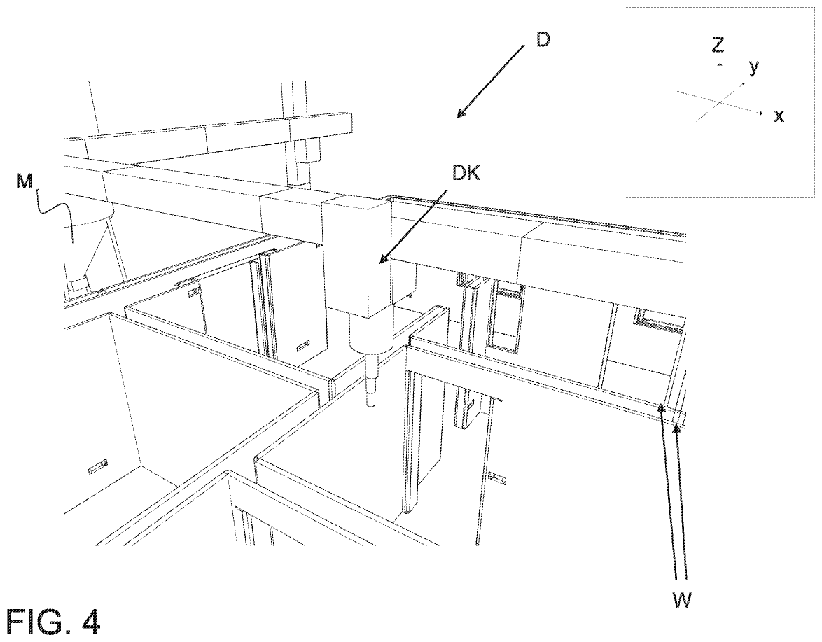

FIG. 4 shows a further perspective view of the 3D printer D. The print head DK of the printer D can move via corresponding actuators on the gantry-like structure in the x, y, and z directions according to the control instructions s instructing it and, in particular, according to a movement portion of the control instructions which defines the movement or path of the print head. The print head DK comprises a print nozzle (which functions as an end effector as it were for positioning and depositing the material to be printed). The print nozzle of the print head can be movable and, in particular, rotatable. A rotatable pressure nozzle has proven to be advantageous because it allows curved radii or curved or bent structures to be traversed in a technically simple manner. Furthermore, the print head can rotate about a vertical axis (z-axis). In FIG. 4, the filament structures are clearly visible and, in the example, shown here consist of two spaced-apart filaments for a wall which form a cavity. Reinforcements can then be inserted into the cavity, which are then filled with filling material (e.g. concrete) at a later stage. The reinforcements are marked with 3 vertical lines on the far right in FIG. 4.

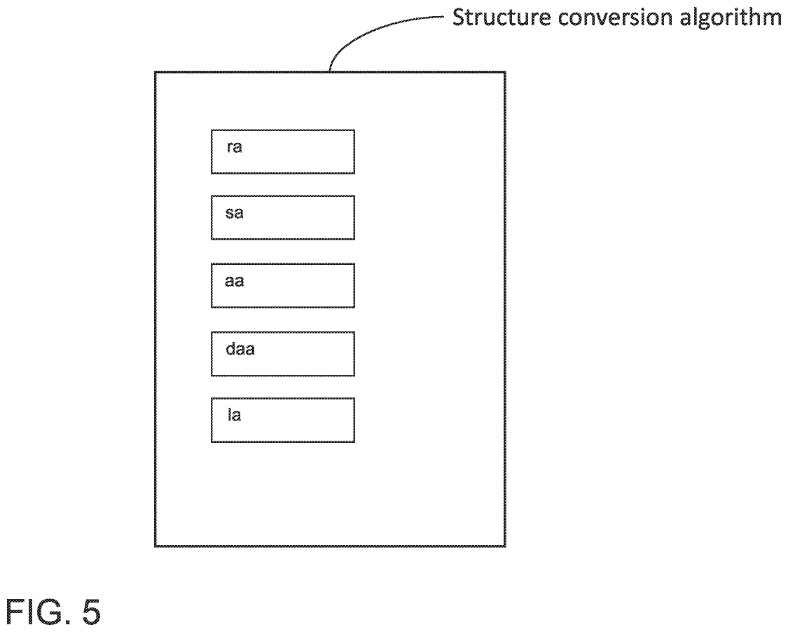

FIG. 5 is a schematic view of possible, optional functions of the structure conversion algorithm. The structure conversion algorithm can include a radius algorithm ra, a slicing algorithm sa, a void algorithm aa, a detail aperture algorithm daa and/or a layer algorithm la.

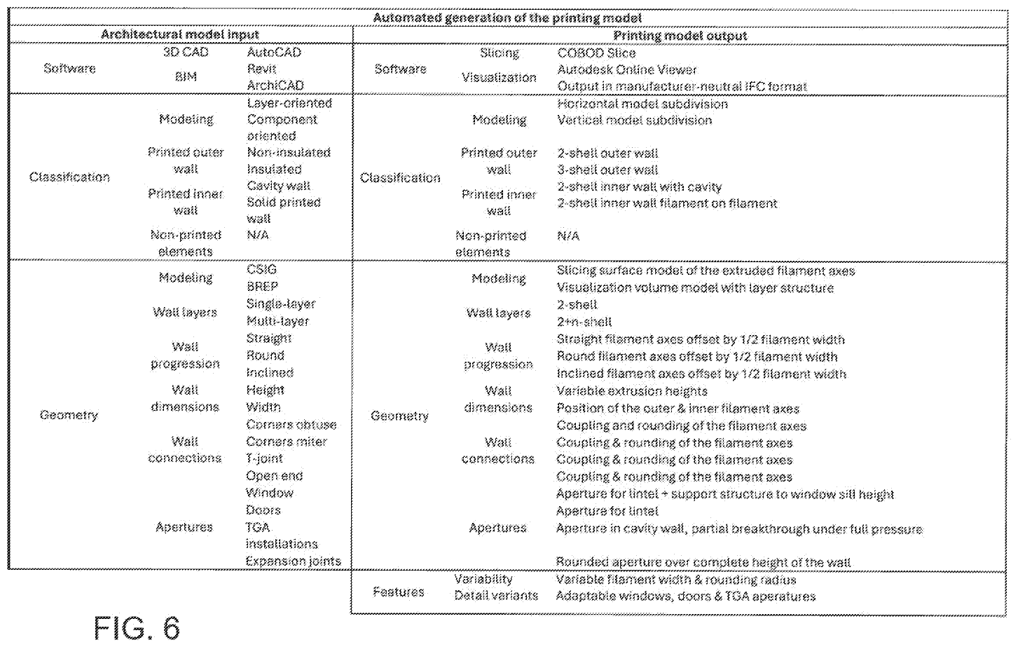

The structure conversion algorithm is designed to classify the read-in structure data of the architectural model with the aid of the classifier K (FIG. 2). The structures to be printed and/or planned by the architect can then be referenced so that they can be accessed further on in the method. The number of filament structures is then determined based upon the read-in wall structure (cf. FIG. 6). In this case, the following function f is provided in order to determine the number of filament walls:

$$f : {number}_{structure data} -> number + {1}_{filament structure data} .$$

A solid wall in the architect's structure data becomes a 2-shell filament structure wall in the filament structure data printed by the printer D. A two-layer wall becomes a 3-layer filament wall etc.

After the number of filament structures has been determined, the positions of the filament structures and in particular the filament axis (as the center longitudinal axis of the wall) are determined. The apertures can then be analyzed (which type of aperture (e.g. window or door or supply lines etc.), which position, which size) and, if necessary, adaptations can be made to the apertures. The adaptations can be e.g. preconfigured and saved in an adaptation data structure.

The reveals, lintels and support structures are then generated and saved in the filament structure data.

Furthermore, apertures for technical building equipment, TGA and expansion joints can be integrated. The expansion joints can be input manually via a user interface, UI. Alternatively, the expansion joints can also be calculated automatically. For this purpose, a complex static model can be used which calculates the expansion of the material in dependence upon the region to be expected (“desert vs. mountain”), the loads arising and the material parameters (e.g. modulus of elasticity).

The vertical edges are rounded with configurable radii by means of the radius algorithm. The minimum radius is simultaneously determined by the filament width. However, the user can also indicate/define larger radii.

Finally, the relative heights of the structures to be printed can be calculated and, if necessary, the structures to be printed can be subdivided into horizontal and/or vertical print portions. This is dependent upon the size of the structure to be printed and of the printer D.

Fundamentally, the correct interpretation of the wall progressions and apertures is important for the error-free generation of control instructions s.

The generated printing model consists of vertical surfaces which are referred to in the CAD environment as polysurfaces. The print file and the geometry included therein must be compatible with the 3D printer software so that it can generate error-free G-code for the 3D concrete printer. The visualization model is to be exported in a native format from the visual programming interface and then is to be retrievable in an online viewer and sent in manufacturer-neutral IFC format to processing nodes connected via an IT network.

By reason of the short setting time of the printable concrete of ca. 4 to 90 min and preferably ca, 15-30 min, tests have shown that a large-area building must be subdivided into practical horizontal and vertical portions before the transfer to the slicing algorithm sa. This ensures that not too much time passes between the successive layers by reason of the movement of the print head. Print pauses are also required in order to mount the inserted window and door lintels. Since this model subdivision is likewise to be solved with the structure conversion algorithm, a sequence should be integrated into the classification of the surface models for the successive portions. With the visualization data v provided for the visualization, a check must be carried to verify the extent to which the existing classification of the architectural model can be transferred to the printable wall structure. By reason of the coupling of outer and inner walls caused by the rounding processes and the multiple-shell character of the filaments, new wall situations are created which must be classified accordingly.

The polysurfaces required for the printing model can be generated by vertical extrusion of the filament axes, each of which must be exactly half a filament width away from the two outer axes of the planned structure, e.g. wall. This is to be guaranteed both for straight and curved wall progressions; laterally inclined wall portions must be extruded along the intended angle of inclination of the wall. In the case of multi-layer walls, a further filament shell is required between the outer filament axes. The required extrusion height of the filaments is to be derived from the input wall.

A particular challenge resides in the coupling and rounding of the various corner joints, T-joints and in the case of open connecting walls.

The same applies to the adaptation of aperture details generated by voids, such as window and door closures, in which, by using the structure conversion algorithm, it is necessary to include not only a rounded, multi-shell reveal but also an additional aperture with the correct embedding height and depth of the lintel to be inserted above the opening. In addition, a printed support structure is required for the windows in order to support the window reveal, which screws in, at window sill height.

Further apertures are provided for the direct integration of technical building fitting installations, which, depending upon the embedding depth and the present wall width, require an opening in the cavity wall between the filaments or a breakthrough through a plurality of filaments. Expansion joints are to be introduced into the outermost filament shell of the outer wall at regular spaced intervals in order to minimize the damaging cracking which is inevitable in temperature-induced and moisture-induced expansion of the concrete.

In order to be able to configure the 3D printing in a variable manner, the filament width and the rounding radius of the wall corners should primarily be individually and quickly adaptable. It is possible to implement an automated variant selection for the window and door connections, which selection can be integrated into the program at a later stage. The visualization model v should be generated on the basis of the printing model in order to be able to exclude any possible deviations. A layer structure, generated directly in the visual programming interface, on the volume surface should likewise be checked.

FIG. 6 shows some conversion parameters used by the structure conversion algorithm. In this case, it can be seen e.g. that a solid wall is converted into a 2-shell filament structure or, more generally, an n-layer wall in the architectural model is transformed into an n+1-layer filament structure.

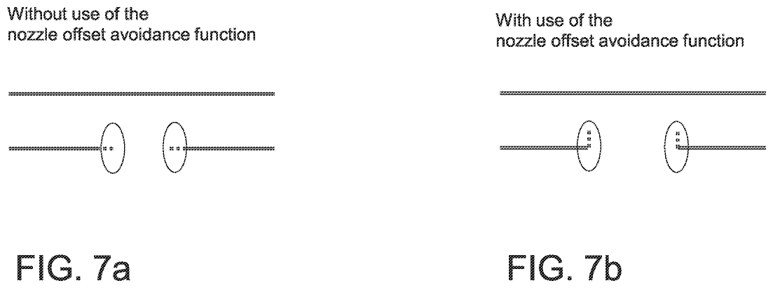

FIG. 7 shows a schematic view of the printing of apertures with and without the implementation of a nozzle offset avoidance function. FIG. 7a shows the variant in which the nozzle offset avoidance function is not used and can result in residual material being deposited in the linear direction of movement even after the printing has stopped (this is illustrated by the dotted line). The critical points at the edges of the aperture are designated by the ellipses in FIGS. 7a and b. In FIG. 7b the nozzle offset avoidance function is used. To this end, the pressure nozzle performs an orthogonally inwardly directed movement and deposits the residual material into the inner region of the cavity wall structure. Again, the excess printing material which issues out of the print nozzle after the printing stop instruction is shown by a dotted line. The nozzle offset avoidance function can be used to ensure that the apertures are printed exactly in terms of size, as planned, and are not reduced in size, e.g. by reason of residual material issuing out.

Finally, it is noted that the description of the invention and the exemplified embodiments are fundamentally to be understood to be non-limiting with respect to a specific physical implementation of the invention. All features explained and illustrated in conjunction with individual embodiments of the invention can be provided in a different combination in the subject matter in accordance with the invention in order to achieve the advantageous effects thereof at the same time.

The scope of protection of the present invention is set by the claims and is not limited by the features explained in the description or shown in the figures.

For a person skilled in the art, it is in particular obvious that the invention can be used not just for gantry printers but also for other 3D printers which are suitable for filament printing. Other building materials can also be used alternatively to or cumulatively with concrete. Furthermore, the components of the transformer can be distributed over a plurality of physical products.

1. Computer-implemented method for actuating a 3D printer (D) for an additive manufacturing method of structures of a construction by means of liquid or powdery printable building materials, comprising the steps of:
reading-in (S1) a 3D model via a CAD interface (I) in which the structures are identifiably represented in structure data in a first design format;
reading-in (S2) printer parameters (par) via a printer interface (DS) which represent requirements and/or design specifications of the 3D printer (D);
executing (S3) a structure conversion algorithm which calculates filament structure data in a second design format for a filament structure from the structure data represented in the first design format, in dependence upon the read-in printer parameters (par);
calculating (S4) control instructions(s) based on the calculated filament structure data, and
communicating (S5) the calculated control instructions(s) to the 3D printer (D) in order to actuate same.

2. Method as claimed in claim 1, wherein the control instructions(s) are represented or can be transformed in a G-code which can be read in and directly processed by a control board of the 3D printer (D).

3. Method as claimed in claim 1, wherein the calculating (S4) of control instructions(s) comprises slicing of the structure (W) to be printed, wherein the slicing is effected by executing a slicing algorithm which calculates slicing data for the calculated filament structure data for selected structures in dependence upon the read-in printer parameters (par) and/or in dependence upon specifications from the read-in 3D model, said slicing data defining in particular a layer height.

4. Method as claimed in claim 1, wherein filament structure parameters are configured via corresponding configuration fields on a user interface (UI) and wherein the structure conversion algorithm is executed based on the filament structure parameters.

5. Method as claimed in claim 1, wherein the printer parameters (par) include a nozzle width and/or a print head printing speed.

6. Method as claimed in claim 1, wherein the filament structure data are generated by means of a BREP (Boundary Representation) method and/or by means of a CSG (Constructive Solid Geometry) method.

7. Method as claimed in claim 1, wherein the method includes a radius algorithm which calculates a radius for all or selected adjacent structure elements which have a connection region via which two adjacent structure elements are connected during a printing procedure.

8. Method as claimed in claim 1, wherein the 3D printer (D) is a gantry printer.

9. Method as claimed in claim 1, wherein the filament structure comprises at least one filament structure element having at least one outer filament which delimits outward construction, and at least one inner filament which delimits inward construction, wherein an outer surface of the outer filament and an outer surface of the inner filament have, in a printed state, a spaced interval from one another which corresponds to a width of the structure from the read-in 3D model.

10. Method as claimed in claim 1, wherein the structure conversion algorithm and/or a void algorithm, is/are implemented with a visual programming language, which can run on a 64-bit Windows application.

11. Method as claimed in claim 1, wherein the method generates, in addition to the calculated control instructions(s), visualization data (v) of a structure from the calculated filament structure data.

12. Method as claimed in claim 1, wherein visualization data (v) can be exported in a standardized format and can be transferred to external entities.

13. Method as claimed in claim 1, wherein the method includes at least one of the following steps:
executing a void algorithm which defines apertures in the structures (W) and, based thereon, calculates aperture volume data in dependence upon the read-in printer parameters (par); and/or
coordinate transformation of the calculated data into a coordinate system of the 3D printer (D).

14. Method as claimed in claim 13, wherein the void algorithm performs a difference operation on the calculated filament structure data and the aperture volume data in order to calculate positive surface data representing a sum of all regions of the structure to be printed.

15. Method as claimed in claim 1, wherein the filament structure data can be exported and modified in an intermediate step and can be fed back to the method in modified form and can be further processed.

16. Method as claimed in claim 1, wherein the building material comprises concrete and/or mortar.

17. Transformer (T) for performing a method as claimed in claim 1 for actuating a 3D printer (D) for an additive manufacturing method of structures of a construction by means of liquid or powdery printable building materials, comprising:
a CAD interface for reading-in a 3D model in which the structures are identifiably represented in structure data in a first design format;
a printer interface for reading-in printer parameters which represent requirements and/or design specifications of the 3D printer;
a processor for executing a structure conversion algorithm which calculates filament structure data in a second design format for a filament structure from the structure data represented in the first design format, in dependence upon the read-in printer parameters;
wherein, furthermore, the processor is intended for calculating control instructions based upon the calculated filament structure data;
an output interface which is designed to provide the control instructions calculated by the processor in order to actuate the 3D printer and to communicate them to the 3D printer.

18. System comprising a transformer as claimed in claim 17, wherein the system comprises the 3D printer.

19. Computer program product, comprising a computer program including instructions which, when the computer program is executed by a computer, cause the computer to perform the method as claimed in claim 1.

20. Method as claimed in claim 1, wherein the additive manufacturing method is filament printing.

21. Method as claimed in claim 1, wherein the 3D model is a BIM-enabled model.

22. Method as claimed in claim 4, wherein the filament structure parameters comprise a width in each case of a filament structure to be calculated and/or a layer height for slicing of the filament structure.

23. Method as claimed in claim 7, wherein the connection region comprises a connection edge.

24. Method as claimed in claim 9, wherein the filament structure comprises at least two filament structure elements.

25. Method as claimed in claim 10, wherein the visual programming language is Rhino by Grasshopper.

26. Method as claimed in claim 11, wherein the visualization data is for 3D visualization, and wherein the method outputs same as a verification step on a user interface.

27. Method as claimed in claim 12, wherein the standardized format is DWG and/or IFC.

28. Method as claimed in claim 13, wherein the calculated data comprises the calculated filament structure data.

29. Method as claimed in claim 15, wherein the filament structure data is exported and modified in the intermediate step in a list format.

30. A transformer as claimed in claim 17, wherein the additive manufacturing method is filament printing.

31. A transformer as claimed in claim 17, wherein the 3D model is a BIM-enabled 3D model.
